(19) United States
(12) Patent Application Publication
(10) Pub. No.: US 2005/0230250 A1
(43) Pub. Date: Oct. 20, 2005

(54) Multilayered gas sensing element

(75) Inventors: Shinichiro Imamura, Chiryu-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/080,447

(22) Filed: Mar. 16, 2005

(30) Foreign Application Priority Data
Apr. 15, 2004 (JP) 2004-120683

(51) Int. Cl. G01N 27/26

(52) U.S. Cl. 204/426; 204/412

(57) ABSTRACT

A multilayered gas sensing element includes a sensor cell and a ceramic heater which are integrally laminated. The sensor cell has a solid electrolytic substrate containing an electrolytic component serving as a main component of the ionic conductive solid electrolyte. The ceramic heater has a heater substrate containing the insulating ceramic as a main component. The solid electrolytic substrate includes a first electrolytic layer containing the insulating ceramic at a position closest to the ceramic heater, and a second electrolytic layer whose insulating ceramic content is smaller than that of the first electrolytic layer.

### CROSS-REFERENCE TO RELATED APPLICATION

This application is based upon and claims the benefit of priority from earlier Japanese Patent Application No. 2004-120683 filed on Apr. 15, 2004 so that the description of which is incorporated herein by reference.

### BACKGROUND OF THE INVENTION

The present invention relates to a multilayered gas sensing element including a sensor cell detecting the concentration of a specific gas in an exhaust gas and a ceramic heater integrally laminated with this sensor cell.

It is conventionally known that a multilayered gas sensing element includes a sensor cell detecting the concentration of a specific gas in an exhaust gas and a ceramic heater integrally laminated with this sensor cell. The sensor cell consists of a measured gas side electrode and a reference gas side electrode provided on both surfaces of a solid electrolytic substrate containing zirconia or the like as a main component. On the other hand, the ceramic heater includes a heater pattern embedded in a heater substrate containing alumina or comparable insulating ceramic as a main component.

In short, the solid electrolytic substrate and the heater substrate laminated with each other to arrange the multilayered gas sensing element are made of different materials. Thus, there is the possibility that warpage or exfoliation (or separation) may occur in a multilayered gas sensing element during the sintering operation due to the difference of shrinkage factors of these different materials. To solve this drawback, the Japanese Patent Application Laid-open No. 2002-71629 proposes adding alumina or comparable insulating ceramic to the solid electrolytic substrate. As the alumina or comparable insulating ceramic is the main component of the heater substrate, it is expected that the difference of heat shrinkage factors of the solid electrolytic substrate and the heater substrate can be reduced.

However, adding the insulating ceramic into the solid electrolytic substrate will lessen the ionic conductivity (i.e. electrolytic conductivity) of the solid electrolytic substrate and accordingly will reduce an output current of the sensor cell (refer to a later-described relationship shown in FIG. 15). On the other hand, lowering the content of insulating ceramic in the solid electrolytic substrate will not be able to sufficiently suppress warpage or exfoliation occurring in the multilayered gas sensing element (refer to a later-described relationship shown in FIG. 14).

### SUMMARY OF THE INVENTION

In view of the above-described problems of the prior art, the present invention has an object to provide a multilayered gas sensing element capable of suppressing warpage or exfoliation (or separation) and also securing satisfactory sensor output.

In order to accomplish the above and other related object, the present invention provides a first multilayered gas sensing element including a sensor cell and a ceramic heater which are laminated integrally. The sensor cell has a solid electrolytic substrate containing an electrolytic component serving as a main component of an ionic conductive solid electrolyte. The ceramic heater has a heater substrate containing an insulating ceramic as a main component. Furthermore, the solid electrolytic substrate of the first multilayered gas sensing element includes a first electrolytic layer provided at a position closest to the ceramic heater and a second electrolytic layer laminated with the first electrolytic layer. The first electrolytic layer contains the insulating ceramic. And, the second electrolytic layer has an insulating ceramic content smaller than that of the first electrolytic layer.

The first multilayered gas sensing element of the present invention brings the following functions and effects.

The solid electrolytic substrate of the present invention has the first electrolytic layer at the position closest to the ceramic heater. The first electrolytic layer contains insulating ceramic. Accordingly, the solid electrolytic substrate can reduce, at the portion near the ceramic heater, the difference of heat shrinkage factors of the solid electrolytic substrate and the ceramic heater. According to this arrangement, it becomes possible to suppress the warpage occurring in the multilayered gas sensing element or the exfoliation (or separation) occurring between the solid electrolytic substrate and the heater substrate during the sintering operation.

Furthermore, the solid electrolytic substrate has the second solid electrolytic layer whose insulating ceramic content is smaller than the insulating ceramic content of the first electrolytic layer. Accordingly, the solid electrolytic substrate can reduce the insulating ceramic content as a whole and can secure satisfactory ionic conductivity. According to this arrangement, the sensor cell can produce a sufficient sensor output.

As described above, the present invention can provide an excellent multilayered gas sensing element capable of suppressing warpage or exfoliation and also securing satisfactory sensor output.

Furthermore, to accomplish the above and other related object, the present invention provides a second multilayered gas sensing element including a sensor cell and a ceramic heater which are laminated integrally. The sensor cell has a solid electrolytic substrate containing an electrolytic component serving as a main component of an ionic conductive solid electrolyte. And, the ceramic heater has a heater substrate containing an insulating ceramic as a main component. The heater substrate of the second multilayered gas sensing element includes an electrolytic component containing layer at a position closest to the solid electrolytic substrate. And, the electrolytic component containing layer contains the electrolytic component serving as a main component of an ionic conductive solid electrolyte. According to second multilayered gas sensing element of the present invention, it becomes possible to suppress warpage or exfoliation occurring in the multilayered gas sensing element due to the difference of heat shrinkage factors of the solid electrolytic substrate and the heater substrate. For example, the electrolytic component containing layer has a thickness of 3 to 600 μm.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view showing a multilayered gas sensing element in accordance with a first embodiment of the present invention;

FIG. 2 is a graph showing a relationship between alumina content and oxygen ionic conductivity of a solid electrolytic substrate in accordance with the first embodiment of the present invention;

FIG. 3 is a cross-sectional view showing a multilayered gas sensing element in accordance with a second embodiment of the present invention;

FIG. 4 is a cross-sectional view showing a multilayered gas sensing element in accordance with a third embodiment of the present invention;

FIG. 5 is a cross-sectional view showing a multilayered gas sensing element in accordance with a fourth embodiment of the present invention;

FIG. 6 is a cross-sectional view showing a multilayered gas sensing element in accordance with a fifth embodiment of the present invention;

FIG. 7 is a graph showing the relationship between alumina content and thickness of a solid electrolytic substrate required to obtain a predetermined sensor output in accordance with the fifth embodiment of the present invention;

FIG. 8 is a cross-sectional view showing a multilayered gas sensing element in accordance with a sixth embodiment of the present invention;

FIG. 9 is a cross-sectional view showing a multilayered gas sensing element in accordance with a seventh embodiment of the present invention;

FIG. 10 is a cross-sectional view showing a multilayered gas sensing element in accordance with an eighth embodiment of the present invention;

FIG. 11 is a cross-sectional view showing an experimental multilayered gas sensing element used as sample in evaluation tests;

FIG. 12 is a graph showing the amount of warpage and the probability of crack generation measured in the evaluation tests;

FIG. 13 is a graph showing the resistance value ratio measured in the evaluation tests;

FIG. 14 is a graph showing the relationship between the alumina content of solid electrolytic substrate and the amount of warpage measured in the evaluation tests;

FIG. 15 is a graph showing the relationship between the alumina content of solid electrolytic substrate and the resistance value ratio obtained in the evaluation tests;

FIG. 16 is a graph showing the relationship between the alumina content of a portion other than the first electrolytic layer and the amount of warpage measured in the evaluation tests;

FIG. 17 is a graph showing the relationship between the alumina content of a portion other than the first electrolytic layer and the resistance value ratio obtained in the evaluation tests;

FIG. 18 is a graph showing the relationship between the alumina content of second electrolytic layer and the amount of warpage measured in the evaluation tests; and

FIG. 19 is a graph showing the relationship between the alumina content in second electrolytic layer and the resistance value ratio obtained in the evaluation tests.

### DESCRIPTION OF THE PREFERRED EMBODIMENTS

As a best mode for embodying the present invention, the inventors of this application provide a first multilayered gas sensing element including a sensor cell and a ceramic heater which are laminated integrally. The sensor cell has a solid electrolytic substrate containing an electrolytic component serving as a main component of an ionic conductive solid electrolyte. The ceramic heater has a heater substrate containing an insulating ceramic as a main component. Furthermore, the solid electrolytic substrate of the first multilayered gas sensing element includes a first electrolytic layer provided at a position closest to the ceramic heater and a second electrolytic layer laminated with the first electrolytic layer. The first electrolytic layer contains the insulating ceramic. And, the second electrolytic layer has an insulating ceramic content smaller than that of the first electrolytic layer.

In the first multilayered gas sensing element of the present invention, the first electrolytic layer needs not be explicitly discriminated from other layer via a boundary surface facing to this different layer of the solid electrolytic substrate. For example, it is possible to define a predetermined region of the solid electrolytic substrate (e.g. a region corresponding to ⅓ of the entire thickness) as the first electrolytic layer.

Furthermore, the electrolytic component of the solid electrolytic substrate is a main component of the ionic conductive solid electrolyte, such as zirconia, barium oxide, and lanthanum oxide. Furthermore, the insulating ceramic is the ceramic having an electric conductivity equal to or less than 10⁻¹⁸Ω¹ cm⁻¹ at a room temperature (25° C.), such as alumina, mullite, spinel, and steatite. Furthermore, it is preferable to provide (i.e. laminate) a gas-permeable diffusion layer on a measured gas surface the sensor cell. In this case, it is possible to provide the diffusion layer on a surface opposed (i.e. not facing) to the ceramic heater. Furthermore, it is possible to provide the diffusion layer between the sensor cell and the ceramic heater.

Furthermore, it is preferable that the second electrolytic layer occupies at least 10% of an entire volume of the solid electrolytic substrate. According to this arrangement, it is possible to greatly reduce the insulating ceramic content of the solid electrolytic substrate and accordingly it is possible to obtain satisfactory sensor output.

Furthermore, it is preferable that the insulating ceramic content of the first electrolytic layer is larger than an entire insulating ceramic content of the solid electrolytic substrate. According to this arrangement, the entire insulating ceramic content of the solid electrolytic substrate is smaller than the insulating ceramic content of the first electrolytic layer. Accordingly, the insulating ceramic content of the solid electrolytic substrate can be further reduced as a whole and accordingly it becomes possible to secure excellent ionic conductivity (i.e. electrolytic conductivity). According to this arrangement, the sensor cell can produce a sufficient sensor output.

Furthermore, it is preferable that the first electrolytic layer has the thickness in the range from 3 to 300 μm. According to this arrangement, it becomes possible to suppress warpage or exfoliation (or separation) occurring in the multilayered gas sensing element and also possible to secure a sufficient sensor output. When the thickness of the first electrolytic layer is less than 3 μm, it is difficult to sufficiently suppress warpage or exfoliation occurring in the multilayered gas sensing element. On the other hand, when the thickness of the first electrolytic layer is larger than 300 μm, it is difficult to obtain satisfactory sensor output.

Furthermore, it is preferable that the solid electrolytic substrate includes a third electrolytic layer at a position farthest from the ceramic heater, and the insulating ceramic content of the third electrolytic layer is smaller than the insulating ceramic content of the solid electrolytic substrate other than the first electrolytic layer. According to this arrangement, the thermal stress acting during the sintering operation can be decentralized, and accordingly it becomes possible to suppress warpage or exfoliation occurring in the multilayered gas sensing element. Furthermore, the insulating ceramic content of the solid electrolytic substrate can be reduced as a whole, and accordingly satisfactory sensor output can be obtained.

Furthermore, it is preferable that the insulating ceramic content of the third electrolytic layer is equal to or less than 50 wt. %. According to this arrangement, it becomes possible to suppress warpage or exfoliation occurring in the multilayered gas sensing element during the sintering operation, and accordingly it becomes possible to obtain satisfactory sensor output. When the insulating ceramic content of the third electrolytic layer exceeds 50 wt. %, the ionic conductive of the solid electrolytic substrate is lessened and accordingly it is difficult to obtain satisfactory sensor output.

Furthermore, it is preferable that the insulating ceramic content of the solid electrolytic substrate decreases with increasing distance from the ceramic heater. According to this arrangement, the thermal stress acting during the sintering operation can be decentralized, and accordingly it becomes possible to suppress warpage or exfoliation occurring in the multilayered gas sensing element. Furthermore, the insulating ceramic content of the solid electrolytic substrate can be reduced as a whole, and accordingly it becomes possible to obtain satisfactory sensor output.

Furthermore, it is preferable that the insulating ceramic content of the first electrolytic layer is in the range from 10 to 80 wt. %. According to this arrangement, it becomes possible to suppress warpage or exfoliation occurring in the multilayered gas sensing element, and accordingly it becomes possible to obtain satisfactory sensor output. When the insulating ceramic content of the first electrolytic layer is less than 10 wt. %, it is difficult to sufficiently reduce the difference of heat shrinkage factors of the solid electrolytic substrate and the heater substrate. Accordingly, it is difficult to sufficiently suppress warpage or exfoliation occurring in the multilayered gas sensing element. On the other hand, when the insulating ceramic content of the first electrolytic layer exceeds 80 wt. %, the ionic conductive of the solid electrolytic substrate is lessened and accordingly it is difficult to obtain satisfactory sensor output of the multilayered gas sensing element.

Furthermore, as a best mode for embodying the present invention, the inventors of this application provide a second multilayered gas sensing element including a sensor cell and a ceramic heater which are laminated integrally. The sensor cell has a solid electrolytic substrate containing an electrolytic component serving as a main component of an ionic conductive solid electrolyte. And, the ceramic heater has a heater substrate containing an insulating ceramic as a main component. The heater substrate of the second multilayered gas sensing element includes an electrolytic component containing layer at a position closest to the solid electrolytic substrate. And, the electrolytic component containing layer contains the electrolytic component serving as a main component of an ionic conductive solid electrolyte.

Moreover, according to the second multilayered gas sensing element of the present invention, it is preferable that the content of the electrolytic component in the electrolytic component containing layer is in a range from 2 to 40 wt. %. According to this arrangement, it becomes possible to suppress warpage or exfoliation occurring in the multilayered gas sensing element while sufficiently securing the insulation properties of the heater substrate. When the content of the electrolytic component in the electrolytic component containing layer is less than 2 wt. %, it is difficult to sufficiently suppress warpage or exfoliation occurring in the multilayered gas sensing element. On the other hand, when the content of the electrolytic component in the electrolytic component containing layer exceeds 40 wt. %, it is difficult to sufficiently secure the insulation properties of the heater substrate. It will be difficult to obtain an accurate sensor output due to adverse influence of the current flowing in the ceramic heater.

Hereinafter, preferred embodiments of the present invention will be explained with reference to attached drawings.

### First Embodiment

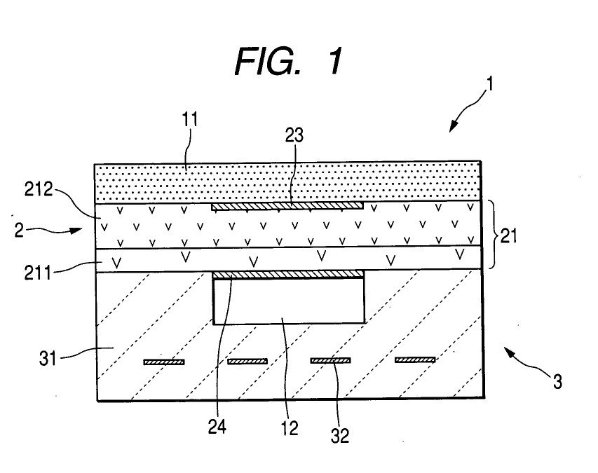

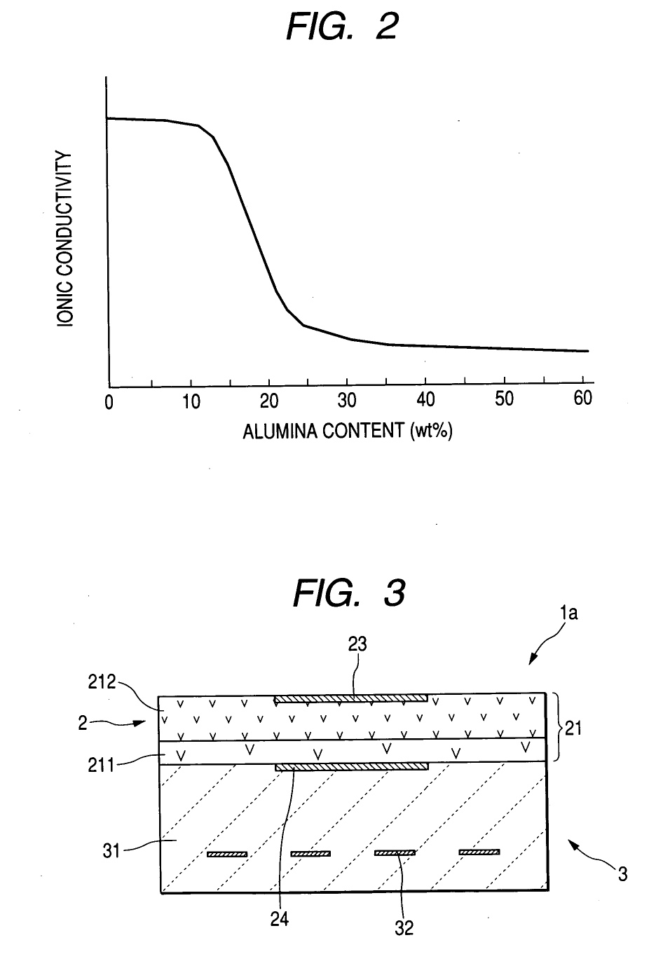

A multilayered gas sensing element in accordance with a first embodiment of the present invention will be explained with reference to FIGS. 1 and 2. The multilayered gas sensing element 1 of this embodiment, as shown in FIG. 1, includes a sensor cell 2 and a ceramic heater 3 integrally laminated. The sensor cell 2 includes a solid electrolytic substrate 21. The ceramic heater 3 includes a heater substrate 31. The solid electrolytic substrate 21 contains zirconia as a main component of the ionic conductive solid electrolyte (i.e. electrolytic main component). Furthermore, the heater substrate 31 contains alumina (i.e. insulating ceramic) as a main component. According to this embodiment, it is possible to use barium oxide or lanthanum oxide as the electrolytic main component of the solid electrolytic substrate 21. It is also possible to use mullite, spinel, or steatite as the insulating ceramic of the heater substrate 31.

The solid electrolytic substrate 21 includes a first electrolytic layer 211 and a second electrolytic layer 212. The first electrolytic layer 211, containing alumina, is disposed at a position closest to the ceramic heater 3. The alumina content of the second electrolytic layer 212 is smaller than the alumina content of the first electrolytic layer 211. The first electrolytic layer 211 has a thickness of 3 to 300 μm. The solid electrolytic substrate 21 has a thickness of 10 to 500 μm. Furthermore, the alumina content of the first electrolytic layer 211 is in the range from 10 to 80 wt. %. The alumina content of the second electrolytic layer 212 is less than 50 wt. % and is, as described above, smaller than the alumina content of the first electrolytic layer 211.

The alumina content can be measured by using an EPMA analyzing apparatus in the following manner.

First of all, preliminary measurement is performed to obtain characteristic X-ray intensities of standard samples (e.g., samples differentiated in the contents of alumina and zirconia) whose contents are already known.

Next, a measuring object sample (i.e. the multilayered gas sensing element 1) is subjected to the measurement of characteristic X-ray intensity.

More specifically, the multilayered gas sensing element 1 is cut along a surface normal to the longitudinal direction of the element to expose a cross-sectional surface as shown in FIG. 1. Then, an electron beam is irradiated to a portion to be measured, to detect the characteristic X-ray intensity which generates as an interaction between the sample and the electron beam. The measured characteristic X-ray intensity of the multilayered gas sensing element 1 is compared with the characteristic X-ray intensities of the standard samples, and further corrected to determine the alumina content.

Hereinafter, the arrangement of the multilayered gas sensing element 1 in accordance with this embodiment will be explained in more detail.

As shown in FIG. 1, a measured gas side electrode 23 to be exposed to a measured gas is provided on one surface of the solid electrolytic substrate 21. A reference gas side electrode 24 to be exposed to a reference gas is provided on the other surface of the solid electrolytic substrate 21. The measured gas side electrode 23, the reference gas side electrode 24, and the solid electrolytic substrate 21 cooperatively arrange the sensor cell 2.

Furthermore, a heater pattern 32 having a heat-generating portion is formed in the heater substrate 31. The heater pattern 32 and the heater substrate 31 cooperatively arrange the ceramic heater 3. Furthermore, a gas-permeable porous diffusion layer 11 is formed on the measured gas side surface of the solid electrolytic substrate 21 so as to cover the measured gas side electrode 23. The porous diffusion layer 11 is a porous member containing zirconia as a main component. The ceramic heater 3, the sensor cell 2, and the porous diffusion layer 11 are integrally laminated in the order.

As shown in FIG. 1, a reference gas chamber 12 is formed as an inner space located between the ceramic heater 3 and the sensor cell 2. The reference gas side electrode 24, located on the lower surface (in FIG. 1), is exposed to the reference gas chamber 12. The multilayered gas sensing element 1 can be manufactured by preparing a green sheet of the heater substrate 31 in which the heater pattern 32 is already formed and a green sheet of the solid electrolytic substrate 21 on the both surfaces of which the measured gas side electrode 23 and the reference gas side electrode 24 are provided, and a green sheet of the porous diffusion layer 4. These three green sheets are laminated and bonded together and then sintered into the multilayered gas sensing element 1.

Next, the functions and effects of this embodiment will be explained.

As shown in FIG. 1, the solid electrolytic substrate 21 has the first electrolytic layer 211 at a position closest to the ceramic heater 3. The first electrolytic layer 211 contains alumina. Accordingly, the solid electrolytic substrate 21 can reduce, at the portion near the ceramic heater 3, the difference of heat shrinkage factors of the solid electrolytic substrate 21 and the ceramic heater 3. According to this arrangement, it becomes possible to suppress warpage occurring in the multilayered gas sensing element 1 or exfoliation (or separation) occurring between the solid electrolytic substrate 21 and the heater substrate 31 during the sintering operation.

Furthermore, the alumina content of the second electrolytic layer 212 is smaller than the alumina content of the first electrolytic layer 211. Accordingly, the solid electrolytic substrate 21 can reduce the alumina content as a whole and can secure excellent ionic conductivity (i.e. electrolytic conductivity). For example, as shown in FIG. 2, it is possible to sufficiently increase the ionic conductivity of the solid electrolytic substrate 21 when the alumina content is equal to or less than 10 wt. %. According to this arrangement, the sensor cell 2 can produce a sufficient sensor output.

Furthermore, the first electrolytic layer 211 has the thickness of 3 to 300 μm. Accordingly, it becomes possible to suppress warpage or exfoliation occurring in the multilayered gas sensing element 1 and secure satisfactory sensor output. Furthermore, the alumina content of the first electrolytic layer 211 is in the range from 10 to 80 wt. %. Accordingly, it becomes possible to sufficiently reduce the difference of heat shrinkage factors of the solid electrolytic substrate 21 and the heater substrate 31. Thus, it becomes possible to sufficiently suppress warpage or exfoliation occurring in the multilayered gas sensing element 1 and also secure excellent ionic conductivity of the solid electrolytic substrate 21 to obtain satisfactory sensor output (refer to FIG. 2).

As described above, this embodiment can provide an excellent multilayered gas sensing element capable of suppressing warpage or exfoliation and securing satisfactory sensor output.

### Second Embodiment

The second embodiment of the present invention, as shown in FIG. 3, discloses a multilayered gas sensing element 1a having no porous diffusion layer (refer to reference numeral 11 in FIG. 1) provided on the sensor cell 2. Furthermore, the multilayered gas sensing element 1a of the second embodiment has no reference gas chamber (refer to reference numeral 12 in FIG. 1) formed as an inner space located between the ceramic heater 3 and the sensor cell 2. The rest of the multilayered gas sensing element 1a is structurally identical with the multilayered gas sensing element 1 explained in the first embodiment. Accordingly, this embodiment can provide an excellent multilayered gas sensing element capable of suppressing warpage or exfoliation and securing satisfactory sensor output. Furthermore, this embodiment can bring the same functions and effects as those of the first embodiment.

### Third Embodiment

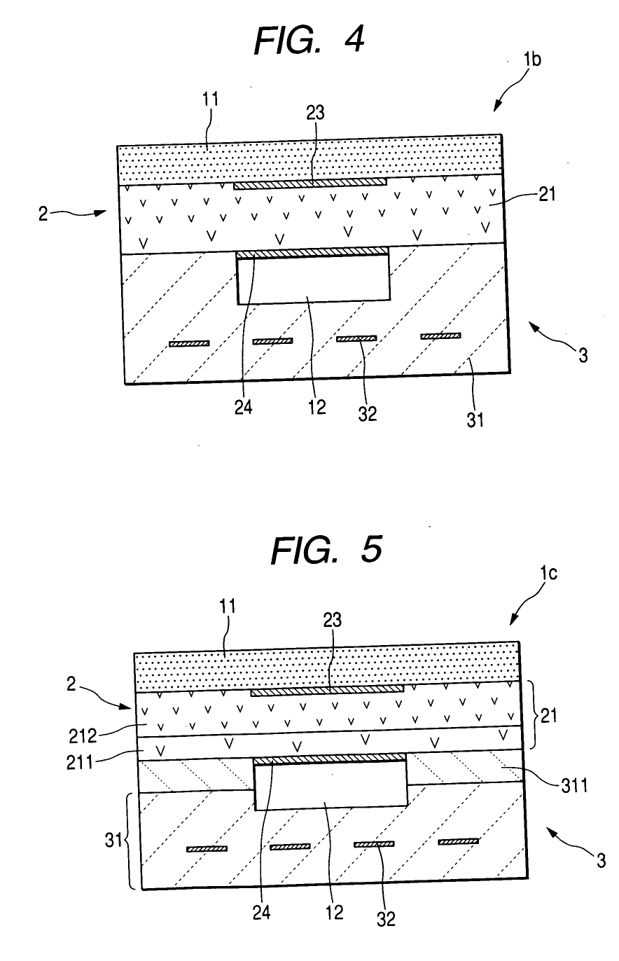

The third embodiment of the present invention, as shown in FIG. 4, discloses a multilayered gas sensing element 1b characterized in that the alumina content of the solid electrolytic substrate 21 decreases with increasing distance from the ceramic heater 3. More specifically, the solid electrolytic substrate 21 has the alumina content gradually decreasing from one side facing to the ceramic heater 3 (i.e. the lower side in FIG. 4) to the other side far from the ceramic heater 3 (i.e. the upper side in FIG. 4). The rest of the multilayered gas sensing element 1b is structurally identical with the multilayered gas sensing element 1 explained in the first embodiment.

According to the arrangement of the third embodiment, it becomes possible to decentralize the thermal stress acting during the sintering operation. Thus, the multilayered gas sensing element 1b of the third embodiment can suppress warpage or exfoliation. Furthermore, the multilayered gas sensing element 1b of the third embodiment can reduce the insulating ceramic content of the solid electrolytic substrate 21 as a whole, and accordingly can obtain satisfactory sensor output. The rest of the multilayered gas sensing element 1b is structurally identical with the multilayered gas sensing element 1 explained in the first embodiment.

### Fourth Embodiment

The fourth embodiment of the present invention, as shown in FIG. 5, discloses a multilayered gas sensing element 1c characterized in that the heater substrate 31 has an electrolytic component containing layer 311 containing zirconia at a position closest to the solid electrolytic substrate 21. The zirconia content of the electrolytic component containing layer 311 is in the range from 2 to 40 wt. %. Furthermore, the thickness of the electrolytic component containing layer 311 is in the range from 3 to 600 μm. The rest of the multilayered gas sensing element 1c is structurally identical with the multilayered gas sensing element 1 explained in the first embodiment.

According to the arrangement of this embodiment, it becomes possible to reduce the difference of heat shrinkage factors of the solid electrolytic substrate 21 and the heater substrate 31. Thus, the multilayered gas sensing element 1c of the fourth embodiment can suppress warpage or exfoliation. Furthermore, when the zirconia content of the electrolytic component containing layer 311 is in the range from 2 to 40 wt. %, it becomes possible to suppress warpage or exfoliation of the multilayered gas sensing element 1c while sufficiently securing insulation ability of the heater substrate 31. Furthermore, this embodiment can bring the same functions and effects as those of the first embodiment.

### Fifth Embodiment

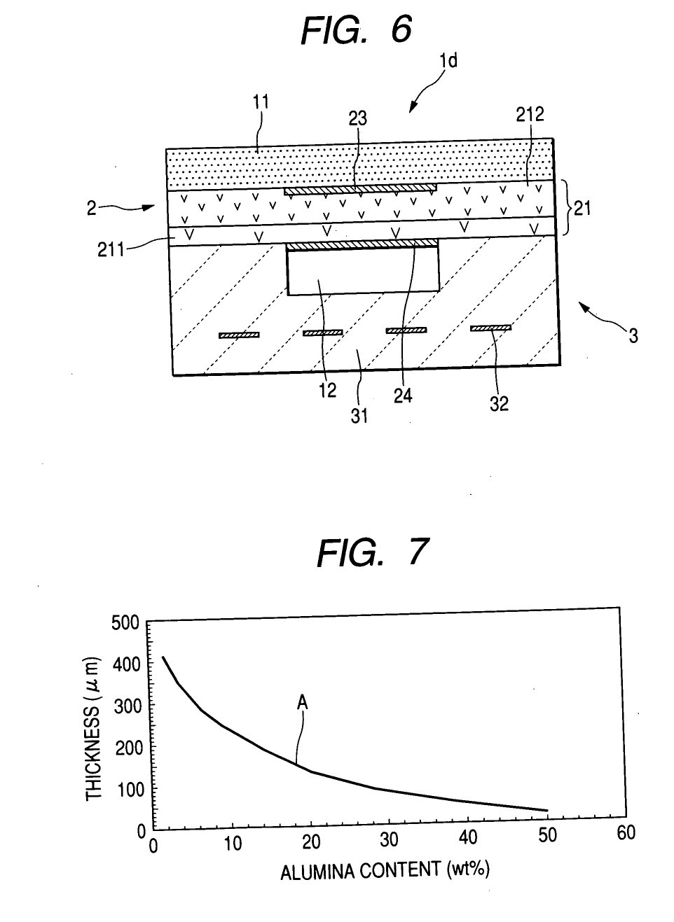

The fifth embodiment of the present invention, as shown in FIG. 6, discloses a multilayered gas sensing element 1d characterized in that the thickness of the solid electrolytic substrate 21 is relatively small. For example, the thickness of the solid electrolytic substrate 21 is 50 μm. The rest of the multilayered gas sensing element 1d is structurally identical with the multilayered gas sensing element 1 explained in the first embodiment.

According to this arrangement, as shown in FIG. 7, it becomes possible to suppress reduction in the sensor output even if the alumina content of the solid electrolytic substrate 21 increases. Furthermore, the multilayered gas sensing element 1d of this embodiment brings the same functions and effects as those of the first embodiment. FIG. 7 is a graph showing the relationship between the alumina content of the solid electrolytic substrate 21 and the thickness of the solid electrolytic substrate 21 required for obtaining a predetermined sensor output. In other words, satisfying the conditions of the curve ‘A’ shown in FIG. 7 makes it possible to produce a sensor output obtainable when the solid electrolytic substrate 21 has the alumina content of 2 wt. % and the thickness of 400 μm.

### Sixth Embodiment

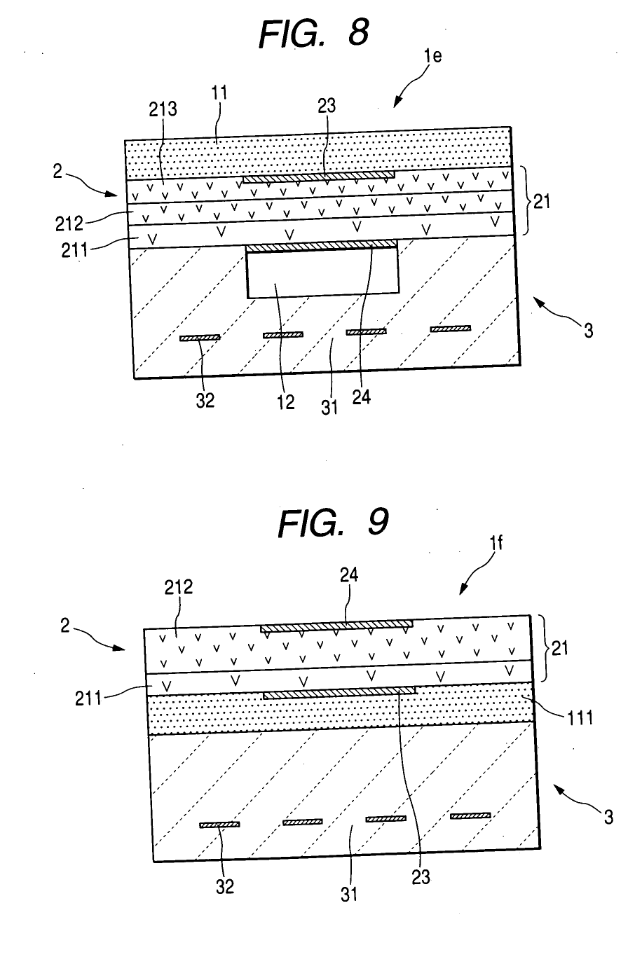

The sixth embodiment of the present invention, as shown in FIG. 8, discloses a multilayered gas sensing element 1e characterized in that the solid electrolytic substrate 21 has a third electrolytic layer 213 at a position farthest from the ceramic heater 3. The third electrolytic layer 213 has the lowest alumina content. The alumina content of the third electrolytic layer 213 is lower than the alumina content of the second electrolytic layer 212.

Furthermore, the second electrolytic layer 212 is disposed between the first electrolytic layer 211 and the third electrolytic layer 213. The first electrolytic layer 211, the second electrolytic layer 212, and the third electrolytic layer 213 have the same thickness equivalent to ⅓ of the entire thickness of the solid electrolytic substrate 21.

Furthermore, the alumina content of the second electrolytic layer 212 is equal to or less than 50 wt. %. Regarding the practical alumina content of the multilayered gas sensing element 1e according to this embodiment, the alumina content of the first electrolytic layer 211 can be set to 50 wt. %, the alumina content of the second electrolytic layer 212 can be set to 10 wt. %, and the alumina content of the third electrolytic layer 213 can be set to 2 wt. %. The rest of the multilayered gas sensing element 1e is structurally identical with the multilayered gas sensing element 1 explained in the first embodiment.

According to the arrangement of this embodiment, the thermal stress acting during the sintering operation can be decentralized. Thus, the multilayered gas sensing element 1e of the sixth embodiment can suppress warpage or exfoliation. Furthermore, the multilayered gas sensing element 1e of the sixth embodiment can reduce the alumina content of the solid electrolytic substrate 21 as a whole, and accordingly can obtain satisfactory sensor output. Furthermore, this embodiment can bring the same functions and effects as those of the first embodiment.

### Seventh Embodiment

The seventh embodiment of the present invention, as shown in FIG. 9, discloses a multilayered gas sensing element 1f characterized in that an intermediate layer 111 is provided between the sensor cell 2 and the ceramic heater 3. According to the arrangement of this embodiment, the alumina content of the intermediate layer 111 is an intermediate value between the alumina contents of the ceramic heater 3 and the solid electrolytic substrate 2. Thus, the intermediate layer 111 of the seventh embodiment has the function of relaxing the difference of thermal expansion coefficients of the ceramic heater 3 and the solid electrolytic substrate 2. The rest of the multilayered gas sensing element 1f is structurally identical with the multilayered gas sensing element 1 explained in the first embodiment, and accordingly brings the same functions and effects as those of the first embodiment.

### Eighth Embodiment

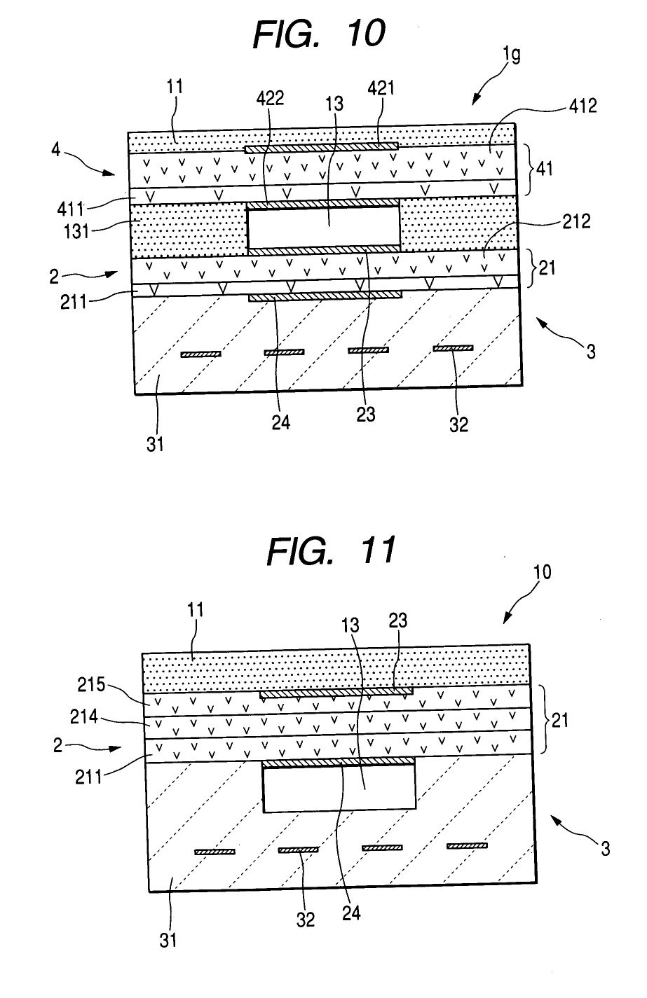

The eighth embodiment of the present invention, as shown in FIG. 10, discloses a 2-cell type multilayered gas sensing element 1g which includes a pump cell 4 in addition to the sensor cell 2. The pump cell 4 is laminated on the measured gas side surface of the sensor cell 2 via a spacer layer 131. The spacer layer 131 defines a measured gas chamber 13 between the sensor cell 2 and the pump cell 4. The pump cell 4 has a pair of pump electrodes 421 and 422 provided on both surfaces of a solid electrolytic substrate 41 containing zirconia as a main component. According to this arrangement, oxygen ions can move between the front and reverse surfaces of the solid electrolytic substrate 41. Furthermore, the porous diffusion layer 11 is laminated on a surface of the solid electrolytic substrate 41 opposed to the sensor cell 2. Furthermore, the ceramic heater 3 is laminated on a surface of the sensor cell 2 opposed to the solid electrolytic substrate 41. The spacer layer 131 includes a porous layer or a hole for introducing the measured gas into the measured gas chamber 13.

The solid electrolytic substrate 41 of the pump cell 4 includes a fourth electrolytic layer 411 containing alumina at the position closest to the ceramic heater 3. Furthermore, the solid electrolytic substrate 41 includes a fifth electrolytic layer 412 whose alumina content is smaller than that of the fourth electrolytic layer 411. For example, the thickness of the fourth electrolytic layer 411 is in the range from 3 to 300 μm. Alternatively, it is possible that the alumina content is uniform everywhere in the solid electrolytic substrate 41. The rest of the multilayered gas sensing element 1g is structurally identical with the multilayered gas sensing element 1 explained in the first embodiment.

According to the arrangement of this embodiment, the solid electrolytic substrate 41 of the pump cell 4 can possess the function of reducing the thermal stress and can sufficiently secure the pumping ability of the pump cell 4. Furthermore, this embodiment can bring the same functions and effects as those of the first embodiment.

### Experimental Data

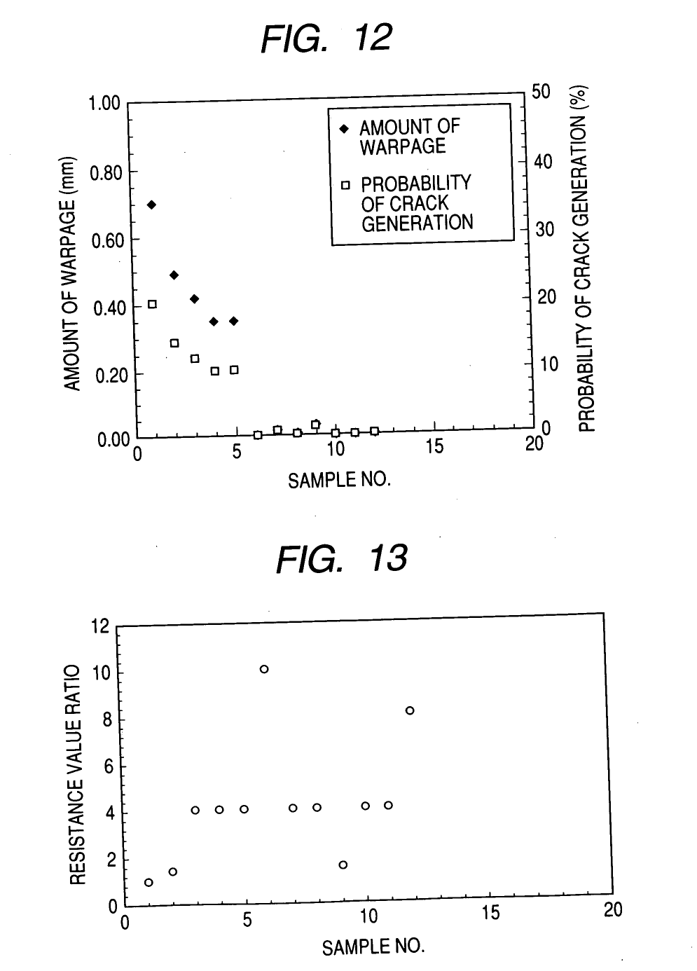

FIGS. 12 to 19 show experimental data obtained in the evaluation tests for checking various characteristics of the multilayered gas sensing element in accordance with the present invention, according to which the alumina content was variously changed in three layers of the solid electrolytic substrate dissected in its thickness direction. FIG. 11 shows an experimental multilayered gas sensing element 10 which is common to the samples used in the evaluation tests. The experimental multilayered gas sensing element 10 is similar in arrangement to the multilayered gas sensing element 1 of the first embodiment of the present invention, although respective samples are differentiated in the alumina content of the solid electrolytic substrate 21.

The solid electrolytic substrate 21 of the experimental multilayered gas sensing element 10 includes a first electrolytic layer 211, an intermediate electrolytic layer 214, and an external electrolytic layer 215 which are disposed or laminated in this order from a boundary facing to the ceramic heater 3. Each of these layers 211, 214, and 215 has a thickness equivalent to ⅓ of the entire thickness of the solid electrolytic substrate 21. More specifically, in the thickness direction of the solid electrolytic substrate 21, a region equivalent to ⅓ of the solid electrolytic substrate 21 from the boundary facing to the ceramic heater 3 is defined as the first electrolytic layer 211. A region equivalent to ⅓ of the solid electrolytic substrate 21 from the boundary facing to the porous diffusion layer 11 is defined as the external electrolytic layer 215. The remaining region of the solid electrolytic substrate 21, intervening between the first electrolytic layer 211 and the external electrolytic layer 215, is defined as the intermediate electrolytic layer 214.

Table 1 shows alumina contents in the first electrolytic layer 211, the intermediate electrolytic layer 214, and the external electrolytic layer 215 of respective samples 1 to 12 used in the evaluation tests. The samples 2-5 and 7-12 are experimental multilayered gas sensing elements according to the present invention. The samples 1 and 6 are experimental multilayered gas sensing elements according to the prior art.

TABLE 1

| | Alumina content (wt. %) | | | |
|---|---|---|---|---|
| | First | Intermediate | External | |
| | electrolytic | electrolytic | electrolytic | |
| Sample | layer | layer | layer | Remark |
| 1 | 2 | 2 | 2 | Prior art |
| 2 | 10 | 10 | 2 | Invention |
| 3 | 10 | 2 | 50 | Invention |
| 4 | 10 | 2 | 50 | Invention |
| 5 | 10 | 50 | 2 | Invention |
| 6 | 50 | 50 | 50 | Prior art |
| 7 | 50 | 2 | 10 | Invention |
| 8 | 50 | 10 | 2 | Invention |
| 9 | 50 | 2 | 2 | Invention |
| 10 | 50 | 10 | 10 | Invention |
| 11 | 50 | 50 | 2 | Invention |
| 12 | 50 | 50 | 10 | Invention |

The measured items in these evaluation tests include the amount of warpage, the probability of crack generation, and the sensor resistance of the multilayered gas sensing element 10 (refer to FIGS. 12 and 13). Regarding the warpage of the multilayered gas sensing element 10, a laminated body of green sheets free from warpage was prepared for each sample and then sintered to measure the amount of warpage generating in each sample.

More specifically, after finishing the sintering operation, the thickness of each tested element was measured at a portion where the thickness is largest. As shown in FIG. 1, each tested element includes the solid electrolytic substrate 21, the porous diffusion layer 11, and the ceramic heater 3 which are laminated integrally. Furthermore, the thickness of each tested element in the longitudinal direction was measured. The amount of warpage of the multilayered gas sensing element 10 was defined by a difference of measured values. FIG. 12 shows the result with respect to the amount of warpage.

Furthermore, the probability of crack generation in the multilayered gas sensing element 10 during the sintering operation was evaluated. To evaluate the crack generation probability, an insulation resistance between the measured gas side electrode 23 and the reference gas side electrode 24 of the sintered multilayered gas sensing element 10 was measured. When the insulation resistance is equal to or less than 500MΩ, it was regarded as indicating the presence of any crack in the sintered multilayered gas sensing element 10. A total of 100 samples were prepared for each test condition. And, the crack generation probability was obtained by counting the number of samples having caused any cracks among 100 samples. FIG. 12 also shows the evaluation result with respect to the crack generation probability.

As understood from FIG. 12, both the amount of warpage and the probability of crack generation were extremely small in the samples 7 to 12. The first electrolytic layers 211 of these samples 7 to 12, located adjacent to the ceramic heater 3, have the alumina content of 50 wt. %. On the other hand, both the amount of warpage and the probability of crack generation were large in the sample 1. The first electrolytic layer 211 of the sample 1 has the alumina content of 2 wt. %. Furthermore, both the amount of warpage and the probability of crack generation of the samples 2 to 5 were smaller than those of the sample 1. The first electrolytic layers 211 of these samples 2 to 5 have the alumina content of 10 wt. %.

As apparent from the test data, the samples 7 to 12 according to the present invention have extremely small values in both the amount of warpage and the probability of crack generation. The samples 2 to 5 according to the present invention have smaller values in both the amount of warpage and the probability of crack generation, compared with the sample 1 according to the prior art.

Next, the sensor resistance of each sample was measured.

Regarding the measuring method, a constant voltage (e.g. 0.5 V) was applied between the measured gas side electrode 23 and the reference gas side electrode 24 of the multilayered gas sensing element 10 shown in FIG. 11, under the condition that the measured gas side electrode 23 was exposed to a measured gas having a predetermined oxygen concentration (e.g. 4%). And, in this condition, the current value flowing between these electrodes was measured. According to this measuring method, the resistance value can be obtained based on the relationship between the voltage and the current measurable until the current value reaches a limiting or critical current. FIG. 13 shows the result of resistance value ratio which represents a ratio of the obtained resistance value of each sample to the resistance value (90Ω) of the sample 1.

As understood from FIG. 13, the sample 6 according to the prior art showed a large sensor resistance because the solid electrolytic substrate 21 of this sample has uniform alumina content of 50 wt. %. On the contrary, the samples 2-5 and 7-12 according to the present invention showed smaller sensor resistances. When the sensor resistance is small, the solid electrolytic substrate 21 has excellent ionic conductivity and accordingly the multilayered gas sensing element 10 can produce large sensor output.

Furthermore, the following analysis can be made based on the obtained test data.

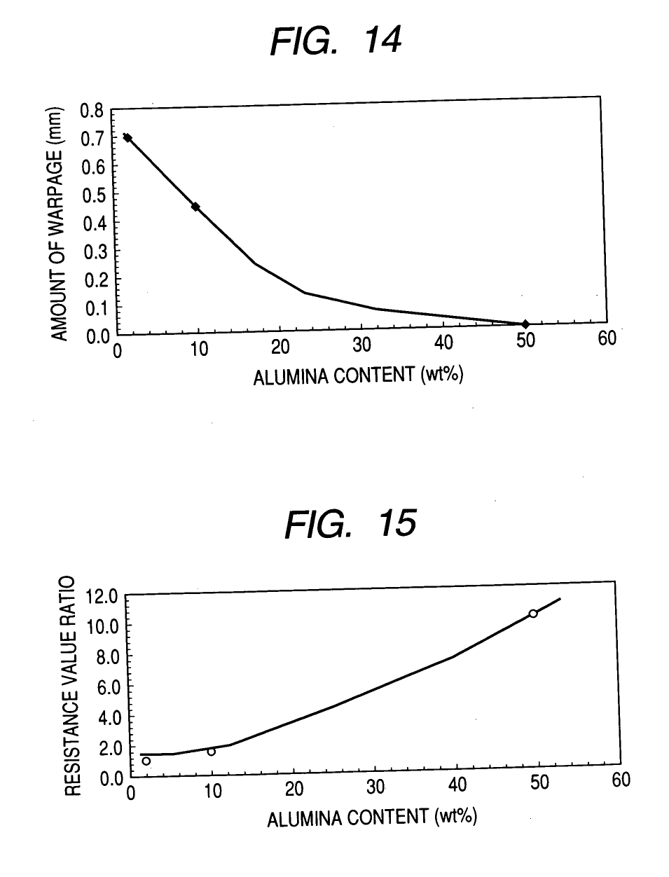

FIGS. 14 and 15 cooperatively show the result of consideration based on the conventional multilayered gas sensing elements whose solid electrolytic substrates 21 have uniform alumina content. The alumina contents of respective solid electrolytic substrates 21 were 2, 10, and 50 wt. %. The test data of FIGS. 14 and 15 are the amounts of warpage and the sensor resistance with respect to these conventional multilayered gas sensing elements.

As understood from FIGS. 14 and 15, the amount of warpage can be decreased by increasing the alumina content. However, the sensor resistance increases on the contrary. The sensor resistance can be decreased by decreasing the alumina content. However, the amount of warpage increases on the contrary. It is therefore concluded that the conventional multilayered gas sensing element cannot simultaneously attain both suppressing warpage and securing satisfactory sensor output.

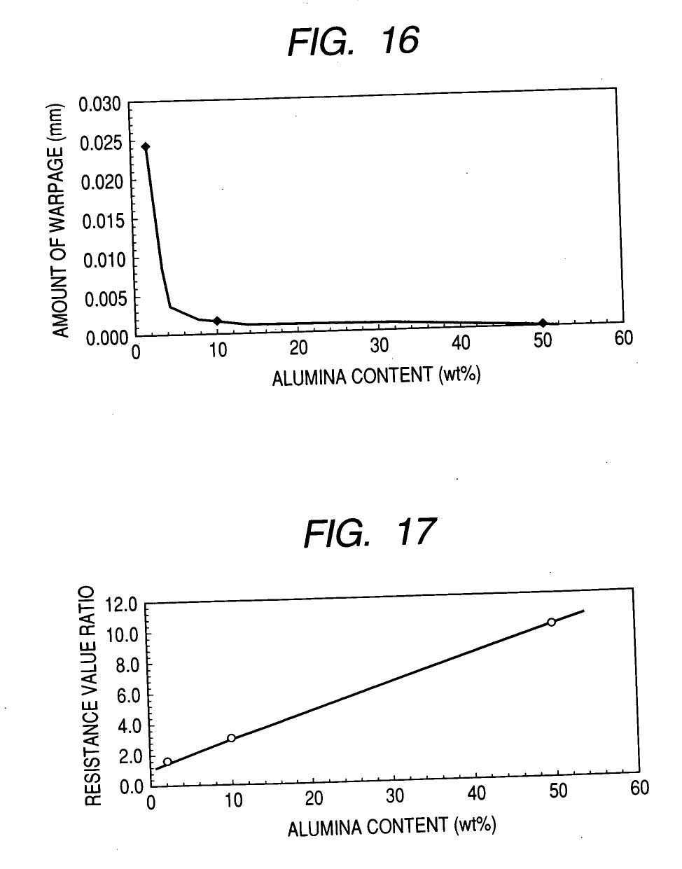

Next, FIGS. 16 and 17 cooperatively show the result of consideration based on the multilayered gas sensing elements 10 which have the first electrolytic layers 211 whose alumina contents were 50 wt. % and the remaining portions whose alumina contents were differentiated. More specifically, the test data shown in FIGS. 16 and 17 correspond to the samples 6, 9, and 10 whose alumina contents were 50 wt. %, 2 wt. %, and 10 wt. %, respectively, in the portions other than the first electrolytic layers 211. The sample 10 is the multilayered gas sensing element according to the prior art. The samples 9 and 10 are the multilayered gas sensing elements according to the present invention.

As understood from FIG. 16, all of the samples 6, 9, and 10 showed smaller warpages less than 0.025 mm. As understood from FIG. 17, there was the tendency that the sensor resistance increases in proportion to the alumina content. The prior art sample 6 showed a large sensor resistance. The present invention samples 9 and 10 showed smaller sensor resistances.

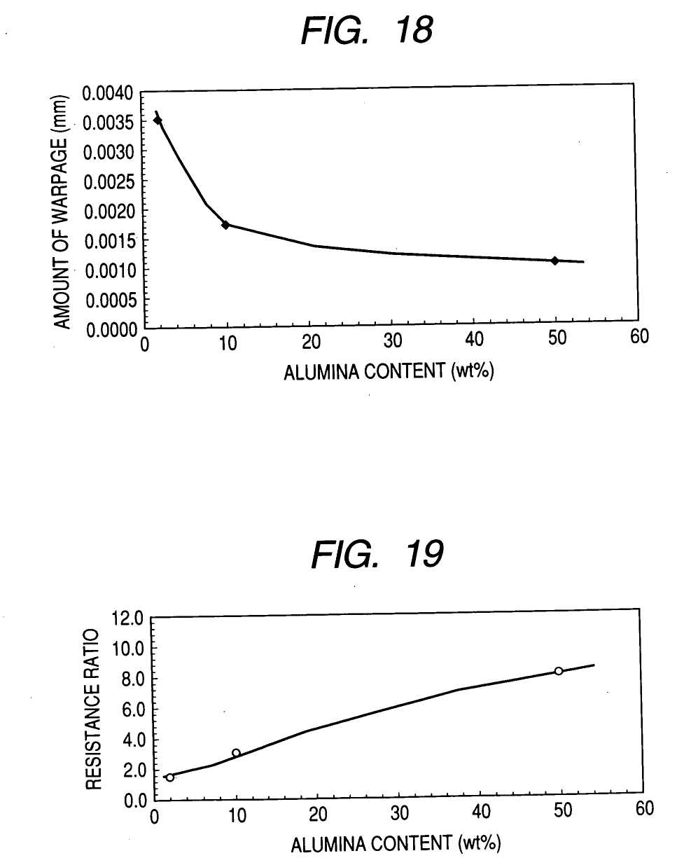

Next, FIGS. 18 and 19 cooperatively show the result of consideration based on the multilayered gas sensing elements 10 which have the first electrolytic layers 211 whose alumina contents were 50 wt. % and the intermediate electrolytic layers 214 whose alumina contents were 10 wt. %. More specifically, the test data shown in FIGS. 18 and 19 correspond to the samples 8 and 10 whose alumina contents in the external electrolytic layers 215 were 2 wt. % and 10 wt. %, respectively. Furthermore, sample 13 having the external electrolytic layer 215 whose alumina content is 50 wt. % was prepared as a new sample. These samples 8, 10, and 13 are the multilayered gas sensing elements according to the present invention.

As understood from FIG. 18, all of the samples 8, 10, and 13 showed smaller warpages equal to or less than 0.0035 mm. As understood from FIG. 19, all of the samples 8, 10, and 13 showed smaller sensor resistances compared with the prior art. As described above, the present invention can provide an excellent multilayered gas sensing element capable of suppressing warpage, crack generation, and sensor resistance.

1. A multilayered gas sensing element comprising a sensor cell and a ceramic heater which are laminated integrally, said sensor cell having a solid electrolytic substrate containing an electrolytic component serving as a main component of an ionic conductive solid electrolyte; and said ceramic heater having a heater substrate containing an insulating ceramic as a main component,
wherein
said solid electrolytic substrate includes a first electrolytic layer provided at a position closest to said ceramic heater and a second electrolytic layer laminated with said first electrolytic layer,
said first electrolytic layer contains said insulating ceramic, and
said second electrolytic layer has an insulating ceramic content smaller than that of said first electrolytic layer.

2. The multilayered gas sensing element in accordance with claim 1, wherein
said second electrolytic layer occupies at least 10% of an entire volume of said solid electrolytic substrate.

3. The multilayered gas sensing element in accordance with claim 1, wherein
the insulating ceramic content of said first electrolytic layer is larger than an entire insulating ceramic content of said solid electrolytic substrate.

4. The multilayered gas sensing element in accordance with claim 1, wherein said first electrolytic layer has a thickness in the range from 3 to 300 μm.

5. The multilayered gas sensing element in accordance with claim 1, wherein
said solid electrolytic substrate includes a third electrolytic layer at a position farthest from said ceramic heater, and
the insulating ceramic content of said third electrolytic layer is smaller than the insulating ceramic content of said solid electrolytic substrate other than said first electrolytic layer.

6. The multilayered gas sensing element in accordance with claim 5, wherein the insulating ceramic content of said third electrolytic layer is equal to or less than 50 wt. %.

7. The multilayered gas sensing element in accordance with claim 1, wherein the insulating ceramic content of said solid electrolytic substrate decreases with increasing distance from said ceramic heater.

8. The multilayered gas sensing element in accordance with claim 1, wherein the insulating ceramic content of said first electrolytic layer is in a range from 10 to 80 wt. %.

9. A multilayered gas sensing element comprising a sensor cell and a ceramic heater which are laminated integrally, said sensor cell having a solid electrolytic substrate containing an electrolytic component serving as a main component of an ionic conductive solid electrolyte; and said ceramic heater having a heater substrate containing an insulating ceramic as a main component,
wherein
said heater substrate includes an electrolytic component containing layer at a position closest to said solid electrolytic substrate, and
said electrolytic component containing layer contains said electrolytic component serving as a main component of an ionic conductive solid electrolyte.

10. The multilayered gas sensing element in accordance with claim 9, wherein the content of said electrolytic component in said electrolytic component containing layer is in a range from 2 to 40 wt. %.
